(19) United States
(12) Patent Application Publication
(10) Pub. No.: US 2002/0128050 A1
(43) Pub. Date: Sep. 12, 2002

(54) Battery for an electronic device and an electronic device using the same

(76) Inventors: Soon-kyo Hong, Seoul (KR); Byoung-young Bae, Gyeonggi-do (KR); Sung-jin Lee, Gyeonggi-do (KR); Young-min Cheong, Seoul (KR)

Correspondence Address: STAAS & HALSEY LLP, 700 11TH STREET, NW, SUITE 500, WASHINGTON, DC, 20001, US

(21) Appl. No.: 09/996,737

(22) Filed: Nov. 30, 2001

(30) Foreign Application Priority Data
Mar. 7, 2001 (KR) 2001-11733

(51) Int. Cl. H04M 1/00

(52) U.S. Cl. 455/572; 455/556

(57) ABSTRACT

An electronic device includes a body, and a battery detachably connected to the body to supply various components in the body with current. The battery includes a memory unit to store information. The memory unit is, optionally, connected to another device. According to such configuration, the electronic device can be portable to easily store required information via the memory unit installed on the battery anytime and anywhere.

### CROSS-REFERENCE TO RELATED APPLICATIONS

This application claims the benefit of Korean Application No. 2001-11733, filed Mar. 7, 2001, in the Korean Industrial Property Office, the disclosure of which is incorporated herein by reference.

### BACKGROUND OF THE INVENTION

1. Field of the Invention

The present invention relates to a battery for an electronic device having a function of storing information and an electronic device using the same.

2. Description of the Related Art

As info-communications areas develop, the use of portable electronic devices such as portable phones has become more widespread. Portable electronic devices have a variety of functions, from wireless Internet surfing to simple audio communication or communication of character based messages.

A portable phone, which is one form of the portable electronic device, is shown in FIG. 1 . The portable phone includes a body 10 having principal parts, such as a controller (not shown) or a display, and a battery 20. The battery 20 is detachable from the body 10 to supply current to the principal parts in the body 10. Thus, the principal parts such as the controller are supplied with current from the battery 20, which allows the principal parts to operate so that various functions, such as communication, are carried out in the body 10.

However, as electronic devices such as the portable phone are more widely used, the electronic devices also require an information storage function to store desired information whenever it is needed. This storage function is often in addition to a general communication function. This is because almost all information is interchanged in a digital file form. Thus, there needs to be a mechanism to rapidly and simply download and store such information anytime and anywhere, and to read it whenever it is needed. In particular, portable electronic devices such as portable phones, which are carried by a user, are most suitable.

A plan for additionally installing a large capacity storage medium in the body 10 was proposed. However, this plan increases the size and complexity of the body 10 in which many principal parts are built. Therefore, even people who do not desire such a large capacity storage medium would have no choice but to carry bulky devices, which would likely generate complaints. Also, electronic devices require an additional transceiving line between them in order to directly interchange information with each other if a storage medium is installed in the body 10, which is inconvenient to use. This transceiving line is required even where the electronic devices are of the same kind.

Accordingly, devices having a new configuration for rapidly simply storing and interchanging information anytime and anywhere are required to make up for these disadvantages.

### SUMMARY OF THE INVENTION

To solve the above and other problems, it is an object of the present invention to provide a battery for an electronic device having a function of rapidly and simply storing and interchanging desired information and an electronic device using the same.

Additional objects and advantages of the invention will be set forth in part in the description which follows and, in part, will be obvious from the description, or may be learned by practice of the invention.

Accordingly, to achieve the above and other objects, an electronic device according to an embodiment of the invention includes a body in which a controller is built and a battery coupled to the body to supply current to the controller, where the battery includes a memory unit.

According to another embodiment of the invention, a battery for an electronic device which is detachable from a body of the electronic device and which includes a memory unit to store information.

### BRIEF DESCRIPTION OF THE DRAWINGS

The above object and advantages of the present invention will become more apparent and more readily appreciated by describing in detail a embodiments thereof with reference to the accompanying drawings in which:

FIG. 1 is a drawing of a conventional electronic device;

FIG. 2 is a drawing of an electronic device and a battery thereof according to an embodiment of the present invention;

FIG. 3 is an exploded perspective view of the battery shown in FIG. 2;

FIGS. 4A through 5B are drawings showing uses of a communication port built into the battery of FIG. 2 according to additional embodiments of the present invention;

FIG. 6 is a drawing showing a use of a power output port built into the battery of FIG. 2 according to a further embodiment of the present invention; and

FIG. 7 is a drawing showing a transformable electronic device and the battery shown in FIG. 2 according to another embodiment of the present invention.

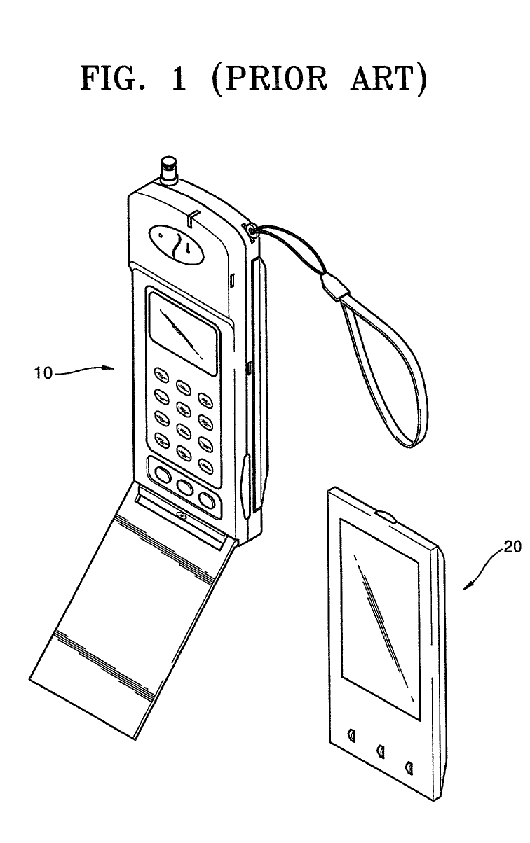

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

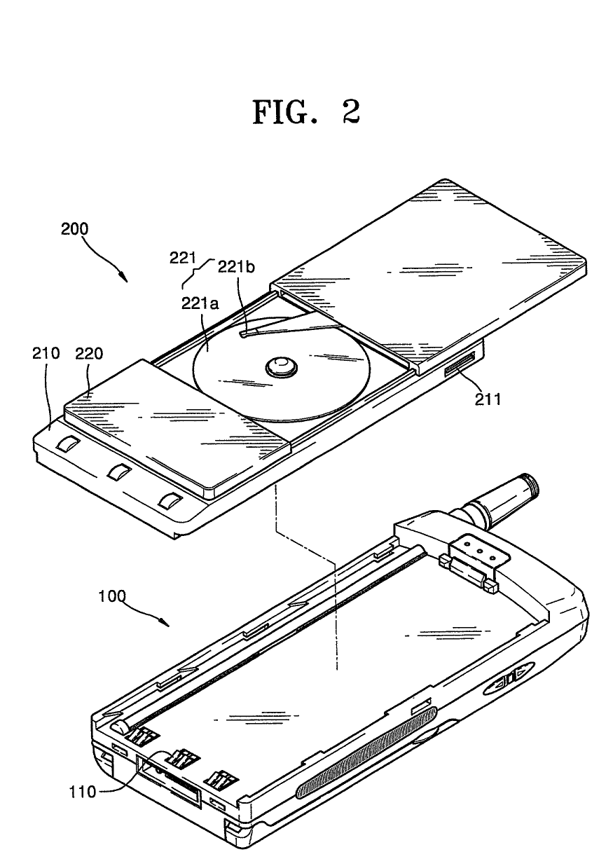

FIG. 2 shows a portable phone, which is an example of an electronic device, and a battery 200 used in the electronic device according to an embodiment the present invention. Referring to FIG. 2, the portable phone of the present invention includes a body 100 and the battery 200 which is detachable from the body 100. The body 100 includes a controller and a variety of main parts (not shown), which are supplied with current from the battery 200 to operate. However, it is understood that other electronic devices, such as personal digital assistants, portable computers, that use a battery 200 for primary or backup power can be used instead of the shown portable phone.

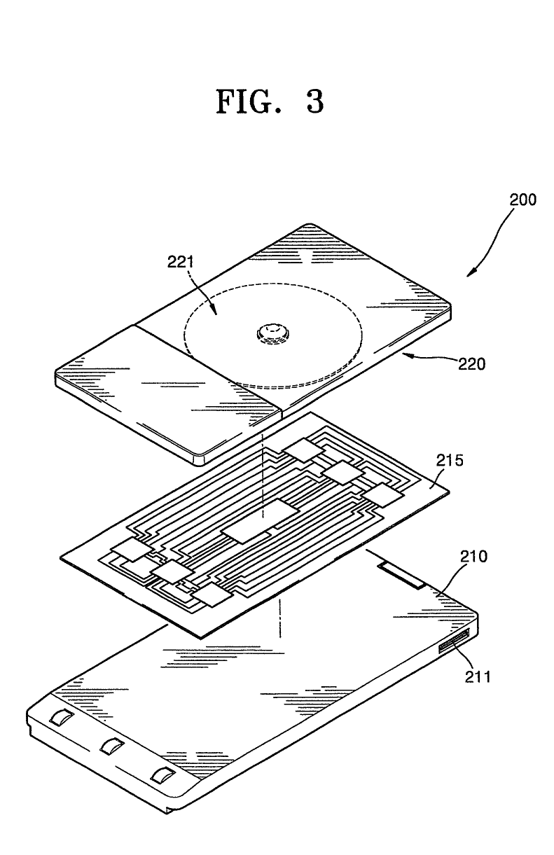

The battery 200, as shown in FIGS. 2 and 3, includes a battery unit 210 to supply current to the electronic device, a memory unit 220 having a disk drive 221 to store information, and a printed circuit board 215 to connect the battery unit 210 and the memory unit 220. In other words, the memory unit 220, which stores and interchanges information with the controller, is installed on the battery 200. The memory unit 220 is supplied with current from the battery unit 210 of the battery 200 to operate. The battery 200 is combined with the body 100. Once combined, connectors 110 in the body 100 connect the printed circuit board 215 with the main parts such as the controller of the body 100. Thus, the controller or other main part can store information, such as information downloaded through a connection to the Internet, in the memory unit 220.

The battery 200 includes a power output port 211 and a communication port 222 as shown in FIGS. 2 through 4C. The battery 200 is connected to other devices as well as to the body 100 of the portable phone using the power output port 211 and the communication port 222. The power output port 211 allows connection of the battery unit 210 to another device, and the communication port 222 allows the memory unit 220 to connect to another device.

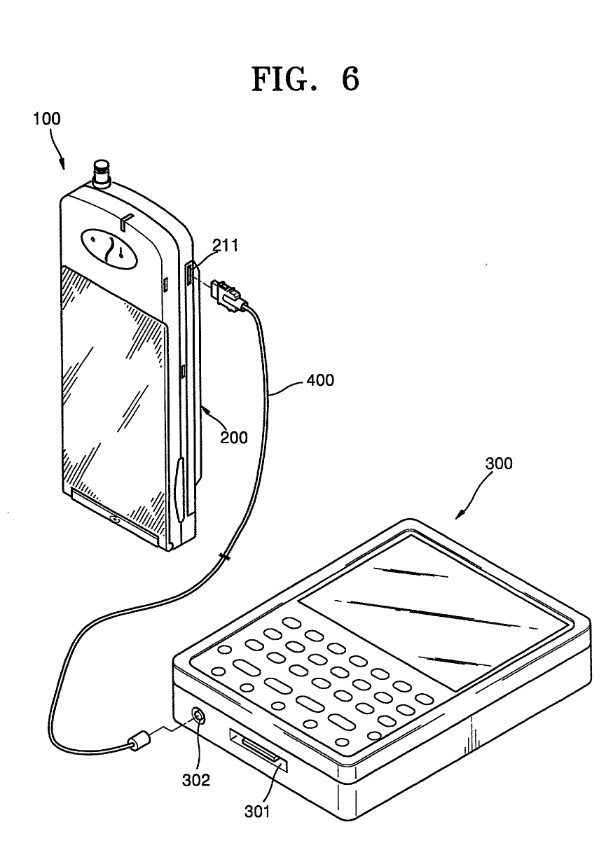

As shown in the embodiment shown in FIG. 6, an end of a power cable 400 plugs into the power output port 211 of the battery 200, and the other end of the power cable 400 is connected to a power input port 302 of another device 300, which can be a portable phone or a personal digital assistant (PDA) or other electronic device to which power is to be supplied. The device 300 is then supplied with power from the battery 200 to operate.

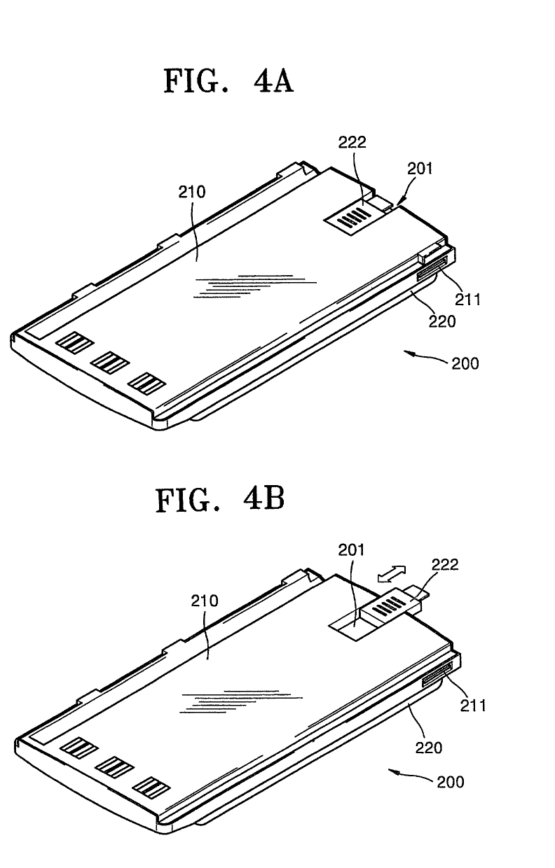

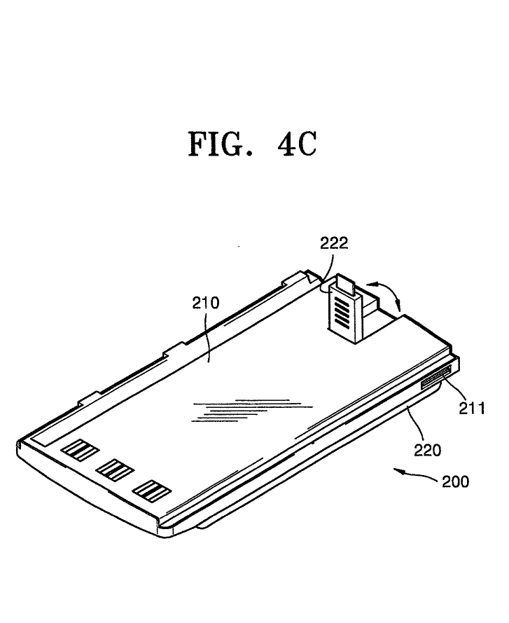

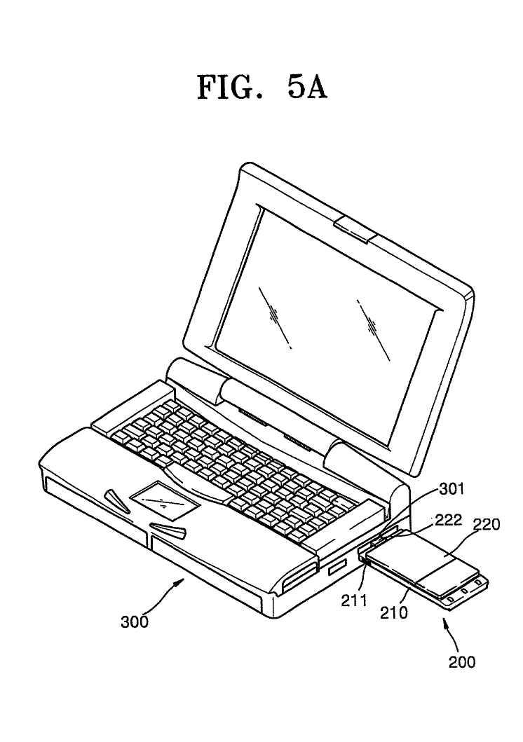

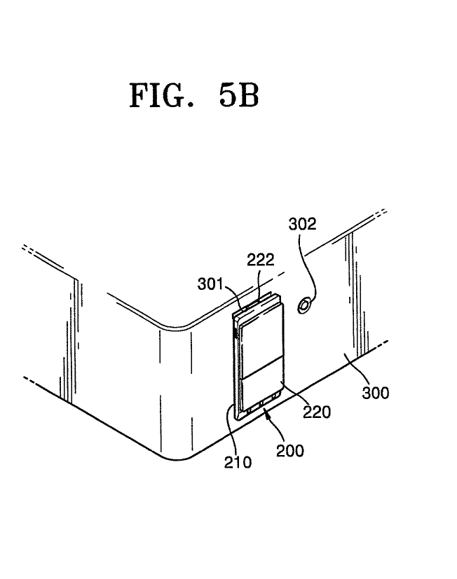

As shown in the embodiment shown in FIGS. 4A, 4B and 5A, the communication port 222 is installed in a slide groove 201 of the battery unit 210 to slide and protrude. Thus, be sliding the communication port 222, the communication port 222 is inserted into a USB port 301 of a computer 300 or a PDA. Thus, when the memory unit 220 is connected to another device 300, such as a PDA, the communication port 222 protrudes and then is inserted into a USB port 301 of the another device 300 to allow information to be exchanged between the memory unit 220 and the device 300.

As shown in the embodiment shown in FIG. 4C, the communication port 222 pivots about one of its ends up to an angle of 90° with respect to the body 210 of the battery 200. As shown in FIG. 5B, the body 210 of the battery 200 may be closely coupled to the device 300 when the communication port 222 is pivoted to 90° in order to be connected in a narrow space. The communication port 222 is at all times internally connected to the memory unit 220 using the printed circuit board 215.

A portable phone having the above-described configuration, and a battery 200 for use in the portable phone are used as described below according to an embodiment of the present invention. A user has an opportunity to select whether the portable phone has an information storage function, as well as a communication function or has only a communication function. In other words, if the portable phone needs an information storage function, the battery 200 having the memory unit 220 is coupled to the body 100. If the portable phone does not need the information storage function, a battery, such as the conventional battery 20 that has only a general battery unit, is coupled to the body 100 instead of the battery 200. Then, it is simple to carry the portable phone and a user can select functions of a portable phone according to a present need.

When the portable phone has the information storage function as shown in FIG. 2, the battery 200 is coupled to the body 100 such that the memory unit 220 is connected to the controller built into the body 100 to store data. Thus, the controller or other main part of the body 100 may store information, such as information downloaded from the Internet, in the memory unit 220, and may also read information stored in the memory unit memory unit 220 and transmit the read information using the Internet. The read information can also be conveyed to the user using a display or other mechanism, and can also be transmitted using other mechanisms.

The memory unit 220 is connected to another device 300 to share information. When a device 300 to be connected to the memory unit 220 is the same kind of portable phone as that to which the battery 200 belongs, the battery 200 is directly detached from the body 100 and is coupled to the body 100 of the other portable phone 300 without an additional connection cable 400 or connection port 301. Then, the battery unit 210 and the memory unit 220 of the battery 200 are connected to the body 100 of the other portable phone 300 using the connecters 110 to supply power and to allow access to stored data and to store new data.

However, when the battery 200 is connected to a different kind of device 300, such as a different kind of portable phone, a notebooks, or a PDA shown in FIG. 5A or 5B, the communication port 222 built into the battery 200 is inserted into the USB port 301 of another device 300. Then, the memory unit 220 is connected to the device 300 using the communication port 222 and the USB port 301 to interchange information with the device 300. Thus, information stored in the memory unit 220 may be transmitted to the device 300, and information stored in the device 300 may be transmitted to the memory unit 220. If the device 300 is supplied with power from the battery unit 220 of the battery 200, as shown in FIG. 6, the power output port 211 of the battery 200 is connected to the power input port 302 of the device 300 using the connection cable 400. Then, the device 300 is supplied with power from the battery 200 of the portable phone to operate.

As described above, in the electronic device of the present invention, the memory unit 220 is installed on the battery 200, and thus the body of the electronic device is not complex and is connected to the Internet or another device anytime and anywhere to store required information simply. Also, a user can select whether a portable phone has an information storage function as well as a communication function or has only a communication function, in consideration of portable convenience.

In the embodiment of the present invention shown in FIG. 2, the memory unit 220 is a hard disk drive in which information is recorded on a disk 221 a using a magnetic head 221 b (See FIG. 2). However, it is understood that a disk drive for use in recording or rerecording information, such as a magnetic or an optical disk drive, which records information on a disk such as a diskette using a magnetic head or records on a recordable optical recording medium using an optical pickup. Also, different types of recording media may be fully used.

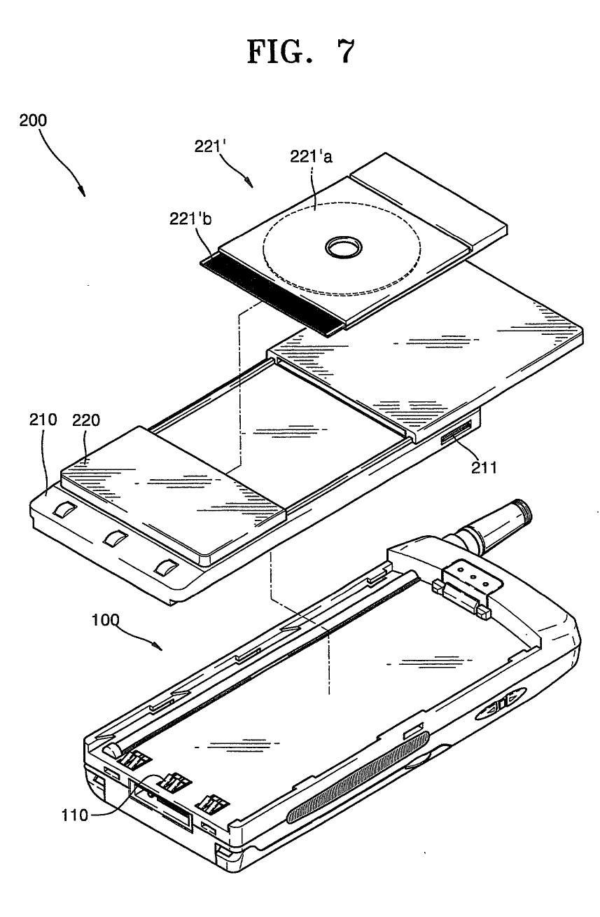

In a further embodiment of the present invention shown in FIG. 7, for convenience in exchange and repair, a disk drive 221′ having a disk portion 221′a and a connecter portion 221′b is packaged so as to be easily detached from the memory unit 220. Also, the disk portion 221a may be detached from the disk drive 221′ in order to change only the disk portion 221′a.

As described above, when the electronic device according to the present invention is used, required information can be easily stored in a memory unit on a battery anytime anywhere. Also, the use of an information storage function can be easily selected only by replacement of a battery. Further, the battery having the memory unit could be used in non-portable electronic devices, such as scientific instruments, electronic vehicles, surveillance aircraft and satellites, and the like, where the replacement of the battery would serve to provide additional energy to the device while allowing retrieval of the stored data from the old battery.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electronic apparatus comprising:
an electronic device including a body; and
a battery coupled to the body to supply current to said electronic device, said battery further comprising a memory unit to store information.

2. The electronic apparatus of claim 1, wherein said battery further comprises a primary power connection to connect to said electronic device, and a secondary power output port to connect to another device to supply current thereto.

3. The electronic apparatus of claim 1, wherein said battery further comprises a primary communication connection to connect to said electronic device, and a secondary communication port to connect the memory unit to another device to exchange information with the another device.

4. The electronic apparatus of claim 3, wherein the secondary communication port is installed to slide so that a free end of the secondary communication port protrudes from said battery to connect with the another device.

5. The electronic apparatus of claim 3, wherein the secondary communication port is disposed to be flipped out from the body of said battery at a predetermined angle.

6. The electronic apparatus of claim 1, wherein the memory unit is detachable from said battery.

7. The electronic apparatus of claim 1, wherein the memory unit comprises a disk drive using a disk as a recording medium.

8. The electronic apparatus of claim 7, wherein the disk is detachable from the memory unit.

9. A battery for an electronic device, comprising:
a memory unit to store information; and
a battery unit to store energy and which is connected to said memory unit,
wherein the battery is detachable from the electronic device.

10. The battery of claim 9, further comprising a primary power connector to connect to the electronic device, and a secondary power output port to connect to another device to supply current thereto.

11. The battery of claim 9, further comprising a primary communication connection to connect to the electronic device, and a secondary communication port to connect said memory unit to another device to exchange information with the another device.

12. The battery of claim 11, wherein said secondary communication port is installed to slide so that a free end of said secondary communication port protrudes from the battery to connect to the another device.

13. The battery of claim 11, wherein said secondary communication port is disposed to be flipped out from a body of the battery at a predetermined angle.

14. The battery of claim 9, wherein said memory unit is detachable from the battery.

15. The battery of claim 9, wherein said memory unit comprises a disk drive using a disk as a recording medium.

16. The battery of claim 15, wherein the disk is detachable from said memory unit.

17. The electronic apparatus of claim 1, wherein the memory unit comprises a drive to record and/or reproduce data with respect to a recording medium.

18. The electronic apparatus of claim 17, wherein the recording medium is detachable from the memory unit.

19. The electronic apparatus of claim 18, wherein the drive is detachable from the memory unit.

20. The battery of claim 9, further comprising a printed circuit board, wherein
said printed circuit board connects said memory unit and said battery unit and provides a communication pathway between said memory unit and the electronic device.

21. The battery of claim 9, wherein said battery unit supplies the stored energy to said memory unit.

22. The battery of claim 21, further comprising power connectors to connect said battery unit to the electronic device to supply the stored energy to the electronic device.

23. A method of storing information and power for use with an electronic apparatus, comprising:
connecting the electronic apparatus to a battery comprising a battery unit to store energy and a memory unit to store information; and
forming a communication pathway between the electronic apparatus and the memory unit to transfer information between the electronic device and the memory unit.

24. The method of claim 23, forming an energy pathway to supply the energy stored in the battery unit to the electronic apparatus while the communication pathway is formed.

25. The method of claim 23, further comprising;
connecting another electronic apparatus to the battery; and
forming another communication pathway between the another electronic apparatus and the memory unit to transfer information between the memory unit and the another electronic apparatus.

26. The method of claim 25, wherein both the electronic apparatus and the another electronic apparatus are connected to the battery at the same time.

27. The method of claim 25, wherein both the electronic apparatus and the another electronic apparatus are not connected to the battery at the same time.

28. The method of claim 27, further comprising detaching the battery from the electronic apparatus prior to said connecting the another electronic apparatus to the battery.

29. The method of claim 28, wherein the electronic apparatus and the another electronic apparatus are of the same kind.

30. The method of claim 23, further comprising:
detaching the battery from the electronic apparatus;
connecting the electronic apparatus to another battery.

31. The method of claim 30, wherein the another battery includes another memory unit.

32. The method of claim 30, wherein the another battery does not include another memory unit.

33. The method of claim 23, further comprising detaching the memory unit from the battery while the battery is connected to the electronic apparatus.

34. The method of claim 23, wherein the memory unit comprises a disk drive and a recording medium accessed by the disk drive, and further comprising detaching the recording medium from the memory unit while the battery is connected to the electronic apparatus.
